(19) United States
(12) Patent Application Publication
(10) Pub. No.: US 2004/0090768 A1
(43) Pub. Date: May 13, 2004

(54) Reflection mechanism for illuminating insignia on a computer system

(76) Inventors: David K.J. Kim, San Jose, CA (US); Milton C. Lee, Mountain View, CA (US); Russell Brovald, Mountain View, CA (US); William W. Ruckman, San Jose, CA (US); Wenjun Chen, Fremont, CA (US)

Correspondence Address: OSHA NOVAK & MAY L.L.P./SUN, 1221 MCKINNEY, SUITE 2800, HOUSTON, TX, 77010, US

(21) Appl. No.: 10/291,313

(22) Filed: Nov. 8, 2002

(51) Int. Cl. F21V 7/00; F21V 33/00

(52) U.S. Cl. 362/85; 362/307; 362/253

(57) ABSTRACT

A reflection mechanism for illuminating insignia on a computer system is provided. The reflection mechanism uses one or more angled reflectors that diffuse light through transparent insignia provided in the housing of the computer system. Such use of angled reflectors reduces hot spots typically attributable to direct light projection and provides uniform illumination of the transparent portions of the insignia.

### BACKGROUND OF INVENTION

A computer system is typically housed in a case, or box, to protect the circuitry (e.g., motherboard), devices (e.g., hard drives), and elements (e.g., wires) necessary for the operational function of the computer system. Such computer system housings may be elongated vertically or horizontally depending on the primary use and or positioning of the computer system. For example, a consumer desiring to position a computer system on his/her desk may choose to buy a horizontally elongated computer system case so that the computer system may be placed on the desk in a least obtrusive position. Alternatively, a consumer desiring to position a computer system on the floor may choose to buy a vertically elongated computer system case that the computer system may be placed on the floor in a least obtrusive and most accessible position.

As marketing and product promotion techniques have progressed, computer system manufacturers have implemented designs in their computer system cases that cause the illumination of company logos, system names, or other insignia associated with a particular computer system. In order to illuminate such insignia, designers typically position a light source, such as a light-emitting diode (LED) array, behind a transparent portion of the computer system case. When the light source sources light, i.e., is ‘on,’ light propagates directly from the light source through the transparent portion, thereby illuminating the transparent portion.

FIG. 1 shows a typical computer system case 10 having a transparent portion 14 capable of being illuminated. The computer system case 10 includes a front cover portion 12 that has a transparent portion 14 arranged to allow light to propagate through from a light source (not shown) positioned/disposed directly behind the transparent portion 14.

However, due to the direct projection of light onto a transparent portion of a computer system case, the transparent portion, and hence the insignia, is susceptible to high temperatures on the externally exposed portion of the transparent portion, thereby making it dangerous for a consumer to touch. Moreover, the direct projection of light behind the transparent portion may result in non-uniform illumination of the transparent portion due to stronger rays of light propagating more intensely through the transparent portion than lateral rays of light projected from the same light source.

### SUMMARY OF INVENTION

According to one aspect of the present invention, a computer system apparatus comprises a housing having a front base portion and a front cover portion adapted to attach to the front base portion, where the front base portion comprises a light source and an angled reflector arranged to diffuse light from the light source through a transparent portion of the front cover portion.

According to another aspect, a computer system assembly comprises: a front base portion; a front cover portion having a transparent portion embedded therein and adapted to attached to the front base portion such that an enclosure allowing light to propagate is formed when the front cover portion is attached to the front base portion; a light source arranged to source light to the enclosure; and a reflector arranged to reflect light propagated in the enclosure and having at least a portion positioned at an angle with respect to the light source, where the reflector is arranged to diffuse light sourced from the light source through the transparent portion.

According to another aspect, a method for illuminating insignia on a computer system comprises: sourcing light in an enclosure of the computer system; and diffusing the sourced light through a transparent portion of the computer system, where the transparent portion having an external visible portion, and where the diffusing comprises reflecting the sourced light at an angle with respect to the sourcing.

According to another aspect, an apparatus comprises: a housing arranged to at least partially enclose a computer system, where the housing encapsulates an enclosure; a light source disposed in the housing and arranged to propagate light to the enclosure; and a reflector disposed along at least a portion of the enclosure and positioned at an angle with respect to the light source, where the reflector is arranged to diffuse light from the light source through a transparent portion of the housing.

Other aspects and advantages of the invention will be apparent from the following description and the appended claims.

### BRIEF DESCRIPTION OF DRAWINGS

FIG. 1 shows a front view of a typical computer system.

FIG. 2 shows a perspective view of a portion of a computer system in accordance with an embodiment of the present invention.

FIG. 3a shows a side view of a portion of a computer system in accordance with an embodiment of the present invention.

FIG. 3b shows a side view of a portion of a computer system in accordance with an embodiment of the present invention.

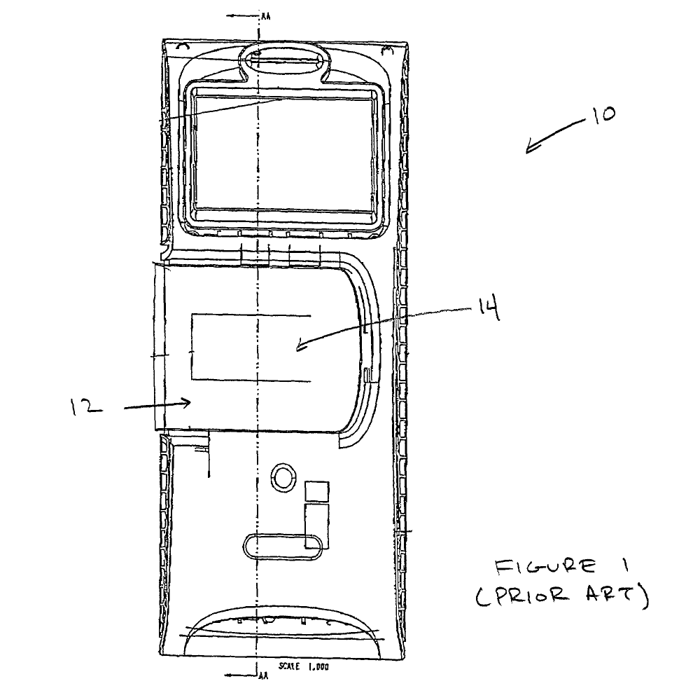

### DETAILED DESCRIPTION

Embodiments of the present invention relate to a reflection mechanism for illuminating insignia on a computer system. The reflection mechanism uses one or more angled reflectors arranged to uniformly diffuse light through a transparent portion of the insignia. Those skilled in the art will note that such an arrangement of angled reflectors in a computer system assembly reduces hot spots typically attributable to direct light projection and provides uniform illumination of insignia associated with a particular computer system assembly.

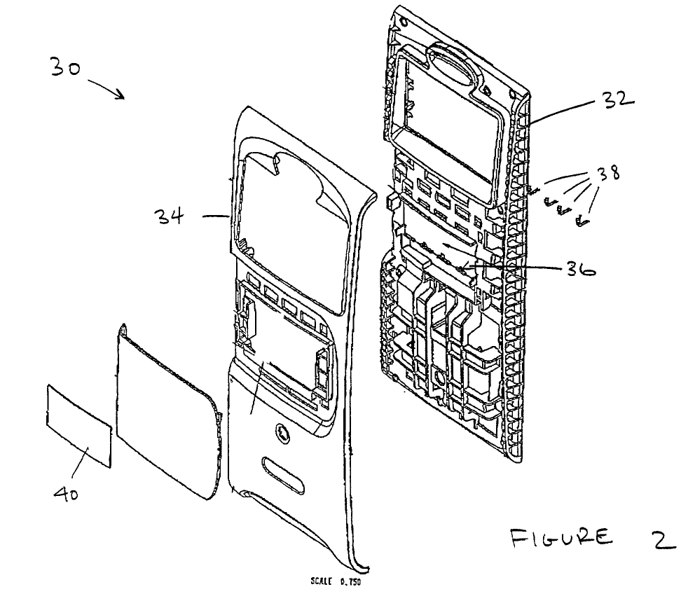

FIG. 2 shows a perspective view of a portion of a computer system 30 in accordance with an exemplary embodiment of the present invention. Shown in FIG. 2, among other things, are a front base portion 32, a front cover portion 34, an angled reflector 36 housed in the front base portion 32, and light sources 38 (e.g., a light-emitting diodes (LEDs)).

An insignia portion 40 having a transparent portion is molded into the front cover portion 34. In one or more other embodiments, the insignia portion 40 may be embedded in an opening (not shown) of the front cover portion 34. Those skilled in the art will understand that the insignia portion 40 may be affixed with/into the front cover portion 34 in a number of other ways without parting from the scope of the present invention.

The light sources 38 can be directly attached to the front base portion 32 such that light from the light sources 38 can be diffused by the angled reflector 36 through the transparent portion of the insignia portion 40 when the front base portion 32 is attached to the front cover portion 34. Those skilled in the art will understand that the front base portion 32 may be attached to the front cover portion 34 by standard screws and/or attaching means that snap the front base portion 32 and the front cover portion 34 together. Moreover, those skilled in the art will understand that, in one or more other embodiments, the light sources 38 may be directly attached to the front cover portion 34.

Such an arrangement, as shown in FIG. 2, allows light from the light source 38 to be diffused uniformly through the transparent portion of the insignia portion 40. Moreover, such a diffusion of light through the transparent portion of the insignia portion 40 reduces hot spots typically attributable to direct light projection common in the prior art. Accordingly, the outer portion (i.e., the portion externally exposed) of the transparent portion of an insignia portion remains at a lower temperature than in those cases where light is directly diffused from the light source through the transparent portion of the insignia portion without the use of an angled reflection mechanism.

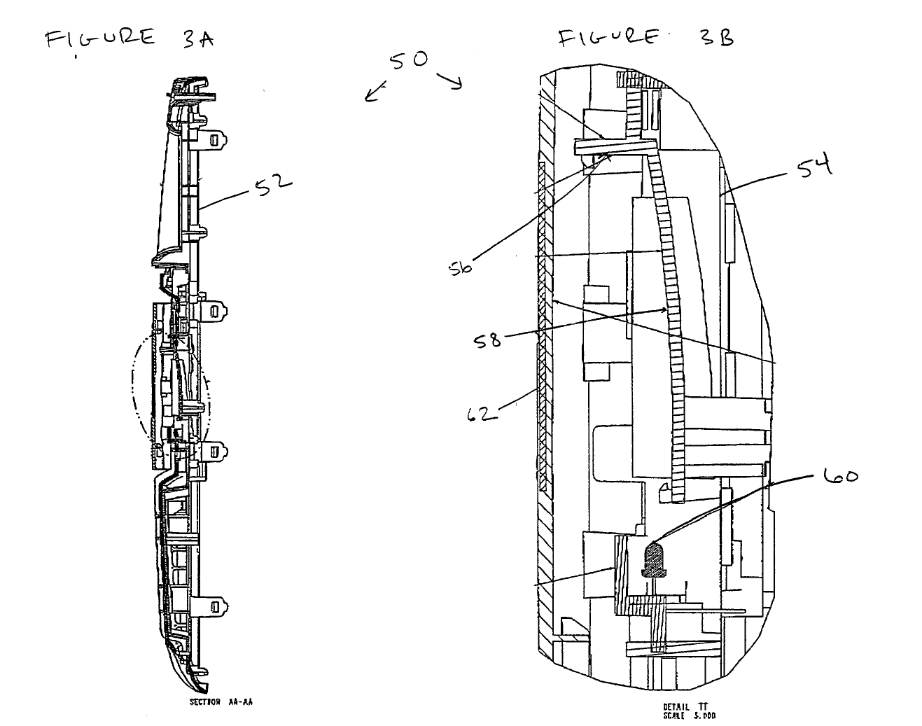

FIGS. 3a and 3b shows side views of a portion of a computer system 50 in accordance with an exemplary embodiment of the present invention. FIG. 3a shows a front cover portion 52 and FIG. 3b shows a front base portion 54 attached to the front cover portion 52 shown in FIG. 3a. Accordingly, the front cover portion 52 is adapted to attach to the front base portion 54.

The front base portion 54 houses angled reflectors 56 and 58 and a light source 60. As ascertainable from FIG. 3b, light from the light source 60 is reflected by angled reflectors 56 and 58 through a transparent portion 62 of the front cover portion 52, where the transparent portion 62, or a portion thereof, is representative of an insignia associated with the computer system 50, or a manufacturer/owner thereof.

In one or more embodiments of the present invention, in-mold decoration (IMD) technology may be used to create a transparent portion. Such a process may start with a molded clear plastic and a pre-fabricated colored insignia that is subsequently inserted into the molded clear plastic.

In one or more other embodiments of the present invention, a housing for the computer system may be in one piece. In other words, the front cover portion and the front base portion may be part of one assembly. In such an embodiment, one or more angled reflectors positioned proximately to an enclosure arranged to allow light from a light source to enter may be used in order to diffuse light through a transparent portion of the single-piece housing.

Advantages of the present invention may include one or more of the following. In one or more embodiments, because an insignia is illuminated by light diffused by reflectors arranged at an angle with respect to a light source of the light, the temperature of the externally exposed portion of the illuminated insignia may be lower than in those cases where light is shone through the insignia directly by the light source.

In one or more embodiments, because angled reflectors are used in a computer system assembly to diffuse light through a transparent insignia, uniform diffusion of light may be achieved, thereby reducing undesirable effects resulting from uneven or non-uniform illumination.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computer system apparatus, comprising:
a housing having a front base portion and a front cover portion adapted to attach to the front base portion, the front base portion comprising:
a light source, and
an angled reflector arranged to diffuse light from the light source through a transparent portion of the front cover portion.

2. The computer system apparatus of claim 1, wherein the transparent portion is representative of an insignia associated with the computer system apparatus.

3. The computer system apparatus of claim 1, wherein the transparent portion is created by an in-mold decoration process.

4. The computer system apparatus of claim 1, wherein the transparent portion is embedded in an opening of the front cover portion.

5. The computer system apparatus of claim 1, wherein an enclosure formed between the front base portion and the front cover portion is arranged for the uniform diffusion of the light by the angled reflector.

6. The computer system apparatus of claim 1, the front base portion further comprising:
another angled reflector arranged to diffuse light from the light source through the transparent portion.

7. The computer system apparatus of claim 1, wherein the light source is a light emitting diode.

8. A computer system assembly, comprising:
a front base portion;
a front cover portion having a transparent portion embedded therein and adapted to attached to the front base portion such that an enclosure allowing light to propagate is formed when the front cover portion is attached to the front base portion;
a light source arranged to source light to the enclosure; and
a reflector arranged to reflect light propagated in the enclosure and having at least a portion positioned at an angle with respect to the light source, wherein the reflector is arranged to diffuse light sourced from the light source through the transparent portion.

9. The computer system assembly of claim 8, wherein the transparent portion is representative of an insignia associated with the computer system assembly.

10. The computer system assembly of claim 8, wherein the transparent portion is created by an in-mold decoration process.

11. The computer system assembly of claim 8, wherein the transparent portion is embedded in an opening of the front cover portion.

12. The computer system assembly of claim 8, wherein the enclosure formed between the front base portion and the front cover portion is arranged for the uniform diffusion of the sourced light by the reflector.

13. The computer system assembly of claim 8, further comprising:
another reflector arranged to reflect light propagated in the enclosure and having at least a portion disposed at an angle with respect to at least one of the reflector and the light source.

14. A method for illuminating insignia on a computer system, comprising:
sourcing light in an enclosure of the computer system; and
diffusing the sourced light through a transparent portion of the computer system, the transparent portion having an external visible portion, wherein the diffusing comprises reflecting the sourced light at an angle with respect to the sourcing.

15. The method of claim 14, wherein the transparent portion corresponds to the insignia.

16. An apparatus, comprising:
a housing arranged to at least partially enclose a computer system, wherein the housing encapsulates an enclosure;
a light source disposed in the housing and arranged to propagate light to the enclosure; and
a reflector disposed along at least a portion of the enclosure and positioned at an angle with respect to the light source, wherein the reflector is arranged to diffuse light from the light source through a transparent portion of the housing.

17. The apparatus of claim 16, wherein the transparent portion corresponds to an insignia associated with the apparatus.

18. The apparatus of claim 16, wherein the light source is a light emitting diode.

19. The apparatus of claim 16, further comprising:
another reflector disposed along at least a portion of the enclosure and positioned at an angle with respect to at least one of the reflector and the light source.

20. The apparatus of claim 16, wherein the transparent portion is disposed in a portion of the housing by an in-mold decoration process.
